(19) United States
(12) Patent Application Publication
(10) Pub. No.: US 2025/0392095 A1
(43) Pub. Date: Dec. 25, 2025

(54) Programmable Threshold Sensing Tag and System Using Ising Dynamics

(71) Applicant: Northeastern University, Boston, MA (US)

(72) Inventors: Nicolas Casilli, Kendall Park, NJ (US); Cristian Cassella, Boston, MA (US); Hussein Hussein, Boston, MA (US); Luca Colombo, Boston, MA (US)

(21) Appl. No.: 19/247,940

(22) Filed: Jun. 24, 2025

Related U.S. Application Data
(60) Provisional application No. 63/663,688, filed on Jun. 24, 2024.

(51) Int. Cl. H01S 3/108; G02F 1/39

(52) U.S. Cl. CPC H01S 3/1083; G02F 1/39; G02F 2203/15

(57) ABSTRACT

Provided herein are Ising tags for multidimensional threshold sensing including at least three parametric oscillators (POs), each coupled to and power-combined with at least one other of the at least three POs, each of the at least three POs configured to passively activate, responsive to a pump signal exceeding a threshold power, wherein an output signal of the PO can be switched between in-phase and out-of-phase, sensor elements each for sensing one of a plurality of PoIs, each coupling two of the POs and configured to set the threshold power of the coupled POs to be exceeded by the pump signal upon violation of a corresponding parameter of interest threshold, wherein a multidimensional sensing threshold is defined as a locus of all combinations of values of the parameters of interest for which the output signals of the POs constructively interfere to increase an output power of the combined output signal.

### CROSS REFERENCE TO RELATED APPLICATIONS

This application claims benefit under 35 U.S.C. § 119(e) of U.S. Provisional Application No. 63/663,688, filed on 24 Jun. 2024, entitled “Programmable Threshold Sensing Tag and System Using Ising Dynamics,” the entirety of which is incorporated by reference herein.

### STATEMENT REGARDING FEDERALLY SPONSORED RESEARCH OR DEVELOPMENT

This invention was made with government support under Grant Number 2103351 awarded by the National Science Foundation. The government has certain rights in the invention.

### BACKGROUND

The fusion of Artificial Intelligence (AI) with the Internet of Things (IoT) has been enabling decision-making processes based on data collected by widespread sensor deployments. This often requires intensive cloud computing resources, which can be impractical when rapid decision-making is needed, like in industrial automation, autonomous vehicles, and healthcare monitoring^{1,2}. Consequently, the IoT is shifting towards the adoption of new wireless sensors offering distributed computing capabilities not relying on cloud connectivity^{3,4}. A key requirement for these new wireless sensors is to perform “threshold sensing”⁵⁻⁸, which involves identifying events where a parameter of interest (PoI) falls outside the range of acceptable values. Threshold sensing is also a key functionality in neural networks where devices emulating neurons “fire” only when their input signal surpasses a certain threshold⁹⁻¹². Unfortunately, current wireless sensors suitable for threshold sensing are active sensors that rely on onboard batteries, making them expensive, bulky, environmentally unfriendly, and necessitating periodic battery replacements and maintenance. This constraint heavily limits their usability in widespread sensor deployments¹³. As a result, there has been increased attention into the adoption of passive wireless sensor devices, namely passive tags (or nodes), to implement threshold sensing¹⁴⁻²⁰.

Contrary to their active counterparts, passive tags are unable to independently recognize violations in their PoI because of their heavily limited signal processing capabilities. A passive tag typically acts as a linear electromagnetic scatterer. As a result, it responds to the interrogation signal produced by an interrogating device (i.e., a “reader”) by generating a backscattered signal with a modulated amplitude or phase dependent on the value of the targeted PoI. Then, it falls upon the reader to determine whether a violation in the targeted PoI at the tag's location has occurred or not, and the reader performs this operation by analyzing the portion of the tag's backscattered signal it receives.

Unfortunately, readers are typically unable to execute this task accurately for two reasons. The first reason, as shown in FIG. 1A, is the occurrence of multipath interference¹⁴⁻¹⁷, wherein passive tags' backscattered signal interacts with the tags' surroundings, leading to distortions in both the amplitude and phase of readers' received signals. These distortions can be severe, especially in indoor or underground environments. The second reason, as shown in FIG. 1B, stems from co-site interference caused by other passive tags monitoring the same PoI at nearby locations. Passive tags, in fact, typically generate a backscattered signal irrespective of the value of the targeted PoI. As a result, they inherently pollute the electromagnetic spectrum by also generating their backscattered signal when no violation in their targeted PoI occurs. This behavior further compromises the readers' ability to successfully extract reliable information from their received signal as it incorporates portions of backscattered signals coming from all the passive tags reached by the interrogation signal. As a result, readers of passive tags currently face even bigger challenges in performing threshold sensing when a dense array of IoT tags is deployed within their interrogation range.

To overcome all these limitations, passive tags should be able to autonomously identify PoI-violations and generate a backscattered signal only when such violations occur, while staying “quiet” when no violation is detected. At the same time, passive tags for threshold sensing should also offer the ability to program their threshold, like their active counterparts. This is particularly important to ensure that the same passive tag can be used in applications that require monitoring a variety of heterogeneous items^{21,22}.

Only recently, passive tags exploiting nonlinear processes have been proposed^{18,19} to overcome the limited signal processing functionalities of linear passive tags and enable an autonomous implementation of threshold sensing. In these nonlinear tags, PoI violations activate an internal oscillation through a subcritical bifurcation, effectively triggering an alarm in the RF spectrum¹⁸. Different from their linear counterparts, these nonlinear tags can naturally exhibit different thresholds depending on the interrogation frequency. However, their reliance on subcritical bifurcations for implementing threshold sensing inevitably results in a large responsivity to fluctuations of their input power. Large fluctuations of these tags' input power can originate from multipath interference or from changes in the distance between these nonlinear passive tags and their reader²⁰. The effect of these fluctuations can be very deleterious, making it challenging to use these tags in indoor or underground settings. Hence, a technological void in passive tags suitable for threshold sensing remains, and developing alternative passive tag technologies has become essential.

In a parallel field of research, the Ising model has been a subject of extensive research over the past 60 years^{23,24}. Originally devised to capture the phenomena driving phase transitions in ferromagnetic materials, this model has been applied to investigate the characteristics of superconductors and other condensed matter systems²⁵. It has also been instrumental in understanding both equilibrium and nonequilibrium phenomena in statistical mechanics, as well as in tackling combinatorial optimization problems that defy traditional von Neumann computing architectures²⁶. In the realm of optimization, the Ising model has been employed to describe the collective behavior of dissipatively coupled parametric oscillators (POs)²⁷⁻³¹. Within this framework, studies have revealed that a network of resistively coupled electrical POs naturally converges towards a collective oscillation state that minimizes a Lyapunov function^{32,33}. This allows the network to evolve towards the ground state configuration of its Hamiltonian, enabling the use of networks of POs to solve combinatorial optimization problems^{27,29,32-34}. While Ising systems formed by dissipatively coupled POs have been previously studied, only a few studies^{28,33} have looked at the exploitation of the same dynamics exploited by these Ising systems in networks of POs coupled by dispersive frequency-dependent components, and these prior works are predominantly theoretical.

### SUMMARY

Described herein are Ising tags having coupled nonlinear parametric oscillators (POs) for threshold sensing of parameters of interest (PoIs). In some embodiments, such Ising tags can function as radio frequency (RF) passive tags (PTs) providing passive, robust, and reprogrammable threshold sensing insensitive to multi-path and reader self-interference. Furthermore, Ising tags having a plurality of coupled POs and sensor elements sensitive to various PoIs can advantageously provide multidimensional threshold sensing wherein the sensing threshold encompasses a locus of all combinations of values of the various PoIs for which the output signals of the POs constructively interfere to increase an output power of Ising tag.

In one aspect, an Ising tag for multidimensional threshold sensing is provided. The Ising tag includes at least three parametric oscillators (POs), each coupled to and power-combined with at least one other of the at least three POs, each of the at least three POs configured to passively activate, responsive to a pump signal exceeding a threshold power of the PO, a parametric oscillation having an oscillation frequency equal to half an angular input frequency of the pump signal, wherein an output signal of the PO can be switched between an in-phase state and an out-of-phase state. The Ising tag also includes a first sensor element for sensing a first parameter of interest, the first sensor element coupling first and second POs of the at least three POs, wherein the first sensor element is configured to set the threshold power of the first and second POs to be exceeded by a power of the pump signal responsive to a value of the first parameter of interest exceeding a first parameter of interest threshold. The Ising tag also includes at least one additional sensor element for sensing at least one additional parameter of interest, the at least one additional sensor element coupling an additional PO of the at least three POs to one of the first PO, the second PO, or a different PO of the at least three POs, wherein the at least one additional sensor element is configured to set the threshold power of the additional PO and the one of the first PO, the second PO, or the different PO to be exceeded by a power of the pump signal responsive to a value of the at least one additional parameter of interest exceeding at least one additional parameter of interest threshold. The Ising tag also includes a power combiner for power-combining output signals produced by the at least three POs to produce a combined output signal. The Ising tag also includes wherein a multidimensional sensing threshold of the Ising tag is defined as a locus of all combinations of values of the first and additional parameters of interest for which the output signals of the at least three POs constructively interfere to increase an output power of the combined output signal.

In some embodiments, the Ising tag also includes at least one resistive element coupling two otherwise uncoupled POs of the at least three POs. In some embodiments, the power combiner is a Wilkinson power combiner. In some embodiments, each PO also includes a resonant input mesh driven by the pump signal. In some embodiments, each PO also includes a resonant output mesh coupled to the input mesh through a nonlinear component to form a parametric frequency divider. In some embodiments, each PO also includes the nonlinear component configured to passively activate, responsive to the pump signal exceeding the threshold power of the PO, the parametric oscillation between the input and output meshes, the parametric oscillation having the oscillation frequency equal to half the angular input frequency of the pump signal. In some embodiments, each PO also includes wherein the output signal of the PO can be switched between the in-phase state and the out-of-phase state. In some embodiments, the first and at least one additional sensor elements have a same resonance frequency when the values of the respective first and at least one additional parameters of interest do not exceed the respective first and at least one additional parameter of interest thresholds. In some embodiments, each of the first and at least one additional sensor elements includes one or more resistive elements, inductive elements, capacitive elements, resonant elements, or combinations thereof. In some embodiments, each of the first and at least one additional sensor elements produces a capacitive readout. In some embodiments, each of the first and at least one additional sensor elements includes a combination of resistive elements, capacitive elements, and resonant elements. In some embodiments, each of the first and at least one additional sensor elements includes one or more of a piezoelectric resonator, a MEMS resonator, a NEMS resonator, or a combination thereof.

In some embodiments, each of the first and at least one additional parameters of interest includes one or more of a physical parameter, an electrical parameter, a chemical agent, a biological agent, or combinations thereof. In some embodiments, each of the first and at least one additional parameters of interest includes one or more of mass, acceleration, pressure, transduced spin waves, vibration frequency, vibration intensity, temperature, humidity, radiation concentration, radiation energy, radiation intensity, radiation type, acoustic frequency, acoustic intensity, acoustic power, acoustic phase, photonic intensity, photonic frequency, photonic phase, photonic polarization, voltage of an electrical signal, current of an electrical signal, power of an electrical signal, frequency of an electrical signal, magnetic field, concentration of a chemical agent, presence or absence of a chemical agent, concentration of a biological agent, presence or absence of a biological agent, or combinations thereof. In some embodiments, at least one of the first and at least one additional parameters of interest includes a chemical agent selected from a gas, a toxin, a volatile organic compound, an atmospheric or water-born pollutant, a vehicle emission, an emission of an animal or human, soil moisture, a pharmaceutical agent or formulation ingredient, a polymer, and combinations thereof. In some embodiments, at least one of the first and at least one additional parameters of interest includes a biological agent selected from a bacterium, a virus, a viral vector, a cell, an exosome, an extracellular vesicle, a cellular organelle or cell fragment, an antibody, a protein, a glycoprotein, a nucleic acid, an antigen, a tumor antigen, a sugar, an oligosaccharide, a polysaccharide, a lipid, a glycolipid, a sphingolipid, a vaccine, and combinations thereof.

In some embodiments, a characteristic of the nonlinear component is modulated at the angular input frequency of the pump signal. In some embodiments, the nonlinear component has a nonlinear reactance. In some embodiments, the nonlinear component includes one or more of a diode, a varactor, or a combination thereof. In some embodiments, the nonlinear component includes a varactor and an inductor, wherein the input mesh and the output mesh are coupled through the varactor and the inductor. In some embodiments, the input mesh includes an input filter to constrain the pump signal within the input mesh to the angular input frequency of the pump signal. In some embodiments, the output mesh includes an output filter to constrain the output signal within the output mesh to half of the angular input frequency of the pump signal. In some embodiments, the output mesh is configured to series-resonate at half the angular input frequency of the pump signal. In some embodiments, each of the input mesh and the output mesh includes a resonator. In some embodiments, each resonator includes one or more of an electrical resonator, a piezoelectric resonator, a MEMS resonator, a NEMS resonator, an optical resonator, a non-Hermitian resonator, an electromagnetic resonator, or a combination thereof.

In another aspect, a system for threshold sensing of multiple parameters of interest is provided. The system includes an Ising tag. The Ising tag includes an input antenna. The Ising tag also includes an output antenna. The Ising tag also includes at least three parametric oscillators (POs), each coupled to and power-combined with at least one other of the at least three POs, each of the at least three POs configured to passively activate, responsive to a pump signal exceeding a threshold power of the PO, a parametric oscillation having an oscillation frequency equal to half an angular input frequency of the pump signal, wherein an output signal of the PO can be switched between an in-phase state and an out-of-phase state. The Ising tag also includes a first sensor element for sensing a first parameter of interest, the first sensor element coupling first and second POs of the at least three POs, wherein the first sensor element is configured to set the threshold power of the first and second POs to be exceeded by a power of the pump signal responsive to a value of the first parameter of interest exceeding a first parameter of interest threshold. The Ising tag also includes at least one additional sensor element for sensing at least one additional parameter of interest, the at least one additional sensor element coupling an additional PO of the at least three POs to one of the first PO, the second PO, or a different PO of the at least three POs, wherein the at least one additional sensor element is configured to set the threshold power of the additional PO and the one of the first PO, the second PO, or the different PO to be exceeded by a power of the pump signal responsive to a value of the at least one additional parameter of interest exceeding at least one additional parameter of interest threshold. The Ising tag also includes a power combiner for power-combining output signals produced by the at least three POs to produce a combined output signal. The Ising tag also includes wherein a multidimensional sensing threshold of the Ising tag is defined as a locus of all combinations of values of the first and additional parameters of interest for which the output signals of the at least three POs constructively interfere to increase an output power of the combined output signal. The system also includes a reader configured to produce the pump signal and to read the output signal, wherein the reader is configured to detect the in-phase or out-of-phase state of the Ising tag.

In some embodiments, the first and at least one additional parameters of interest each include one or more of a physical parameter, an electrical parameter, a chemical agent, a biological agent, or combinations thereof.

Additional features and aspects of the technology include the following:
1. An Ising tag for multidimensional threshold sensing comprising:

at least three parametric oscillators (POs), each coupled to and power-combined with at least one other of the at least three POs, each of the at least three POs configured to passively activate, responsive to a pump signal exceeding a threshold power of the PO, a parametric oscillation having an oscillation frequency equal to half an angular input frequency of the pump signal, wherein an output signal of the PO can be switched between an in-phase state and an out-of-phase state;

a first sensor element for sensing a first parameter of interest, the first sensor element coupling first and second POs of the at least three POs, wherein the first sensor element is configured to set the threshold power of the first and second POs to be exceeded by a power of the pump signal responsive to a value of the first parameter of interest exceeding a first parameter of interest threshold; and

at least one additional sensor element for sensing at least one additional parameter of interest, the at least one additional sensor element coupling an additional PO of the at least three POs to one of the first PO, the second PO, or a different PO of the at least three POs, wherein the at least one additional sensor element is configured to set the threshold power of the additional PO and the one of the first PO, the second PO, or the different PO to be exceeded by a power of the pump signal responsive to a value of the at least one additional parameter of interest exceeding at least one additional parameter of interest threshold; and

a power combiner for power-combining output signals produced by the at least three POs to produce a combined output signal,

wherein a multidimensional sensing threshold of the Ising tag is defined as a locus of all combinations of values of the first and additional parameters of interest for which the output signals of the at least three POs constructively interfere to increase an output power of the combined output signal.
2. The Ising tag of feature 1, further comprising at least one resistive element coupling two otherwise uncoupled POs of the at least three POs.
3. The Ising tag of any of features 1-2, wherein the power combiner is a Wilkinson power combiner.
4. The Ising tag of any of features 1-3, wherein each PO further comprises:

a resonant input mesh driven by the pump signal;

a resonant output mesh coupled to the input mesh through a nonlinear component to form a parametric frequency divider; and

the nonlinear component configured to passively activate, responsive to the pump signal exceeding the threshold power of the PO, the parametric oscillation between the input and output meshes, the parametric oscillation having the oscillation frequency equal to half the angular input frequency of the pump signal,

wherein the output signal of the PO can be switched between the in-phase state and the out-of-phase state.
5. The Ising tag of feature 4, wherein the first and at least one additional sensor elements have a same resonance frequency when the values of the respective first and at least one additional parameters of interest do not exceed the respective first and at least one additional parameter of interest thresholds.
6. The Ising tag of any of features 1-5, wherein each of the first and at least one additional sensor elements includes one or more resistive elements, inductive elements, capacitive elements, resonant elements, or combinations thereof.
7. The Ising tag of feature 6, wherein each of the first and at least one additional sensor elements produces a capacitive readout.
8. The Ising tag of any of features 6-7, wherein each of the first and at least one additional sensor elements includes a combination of resistive elements, capacitive elements, and resonant elements.
9. The Ising tag of any of features 6-8, wherein each of the first and at least one additional sensor elements includes one or more of a piezoelectric resonator, a MEMS resonator, a NEMS resonator, or a combination thereof.
10. The Ising tag of any of features 1-9, wherein each of the first and at least one additional parameters of interest includes one or more of a physical parameter, an electrical parameter, a chemical agent, a biological agent, or combinations thereof.
11. The Ising tag of feature 10, wherein each of the first and at least one additional parameters of interest includes one or more of mass, acceleration, pressure, transduced spin waves, vibration frequency, vibration intensity, temperature, humidity, radiation concentration, radiation energy, radiation intensity, radiation type, acoustic frequency, acoustic intensity, acoustic power, acoustic phase, photonic intensity, photonic frequency, photonic phase, photonic polarization, voltage of an electrical signal, current of an electrical signal, power of an electrical signal, frequency of an electrical signal, magnetic field, concentration of a chemical agent, presence or absence of a chemical agent, concentration of a biological agent, presence or absence of a biological agent, or combinations thereof.
12. The Ising tag of any of features 10-11, wherein at least one of the first and at least one additional parameters of interest includes a chemical agent selected from a gas, a toxin, a volatile organic compound, an atmospheric or water-born pollutant, a vehicle emission, an emission of an animal or human, soil moisture, a pharmaceutical agent or formulation ingredient, a polymer, and combinations thereof.
13. The Ising tag of any of features 10-12, wherein at least one of the first and at least one additional parameters of interest includes a biological agent selected from a bacterium, a virus, a viral vector, a cell, an exosome, an extracellular vesicle, a cellular organelle or cell fragment, an antibody, a protein, a glycoprotein, a nucleic acid, an antigen, a tumor antigen, a sugar, an oligosaccharide, a polysaccharide, a lipid, a glycolipid, a sphingolipid, a vaccine, and combinations thereof.
14. The Ising tag of any of features 4-13, wherein a characteristic of the nonlinear component is modulated at the angular input frequency of the pump signal.
15. The Ising tag of any of features 4-14, wherein the nonlinear component has a nonlinear reactance.
16. The Ising tag of feature 15, wherein the nonlinear component includes one or more of a diode, a varactor, or a combination thereof.
17. The Ising tag of feature 16, wherein the nonlinear component includes a varactor and an inductor, wherein the input mesh and the output mesh are coupled through the varactor and the inductor.
18. The Ising tag of any of features 4-17, wherein:

the input mesh includes an input filter to constrain the pump signal within the input mesh to the angular input frequency of the pump signal; and

the output mesh includes an output filter to constrain the output signal within the output mesh to half of the angular input frequency of the pump signal.
19. The Ising tag of any of features 4-18, wherein the output mesh is configured to series-resonate at half the angular input frequency of the pump signal.
20 The Ising tag of any of features 4-19, wherein each of the input mesh and the output mesh includes a resonator.
21. The Ising tag of feature 20, wherein each resonator includes one or more of an electrical resonator, a piezoelectric resonator, a MEMS resonator, a NEMS resonator, an optical resonator, a non-Hermitian resonator, an electromagnetic resonator, or a combination thereof.
22. A system for threshold sensing of multiple parameters of interest comprising:

an Ising tag including:
an input antenna;
an output antenna;
at least three parametric oscillators (POs), each coupled to and power-combined with at least one other of the at least three POs, each of the at least three POs configured to passively activate, responsive to a pump signal exceeding a threshold power of the PO, a parametric oscillation having an oscillation frequency equal to half an angular input frequency of the pump signal, wherein an output signal of the PO can be switched between an in-phase state and an out-of-phase state;
a first sensor element for sensing a first parameter of interest, the first sensor element coupling first and second POs of the at least three POs, wherein the first sensor element is configured to set the threshold power of the first and second POs to be exceeded by a power of the pump signal responsive to a value of the first parameter of interest exceeding a first parameter of interest threshold;
at least one additional sensor element for sensing at least one additional parameter of interest, the at least one additional sensor element coupling an additional PO of the at least three POs to one of the first PO, the second PO, or a different PO of the at least three POs, wherein the at least one additional sensor element is configured to set the threshold power of the additional PO and the one of the first PO, the second PO, or the different PO to be exceeded by a power of the pump signal responsive to a value of the at least one additional parameter of interest exceeding at least one additional parameter of interest threshold; and
a power combiner for power-combining output signals produced by the at least three POs to produce a combined output signal,
wherein a multidimensional sensing threshold of the Ising tag is defined as a locus of all combinations of values of the first and additional parameters of interest for which the output signals of the at least three POs constructively interfere to increase an output power of the combined output signal; and

a reader configured to produce the pump signal and to read the output signal, wherein the reader is configured to detect the in-phase or out-of-phase state of the Ising tag.
23. The system for threshold sensing of multiple parameters of interest of feature 22, wherein the first and at least one additional parameters of interest each include one or more of a physical parameter, an electrical parameter, a chemical agent, a biological agent, or combinations thereof.

### BRIEF DESCRIPTION OF THE DRAWINGS

FIG. 1A illustrates a symbolic schematic representation of multipath interference associated with prior art passive tags, which inevitably distorts the portion of the prior art passive tags' backscattered signal received by a reader.

FIG. 1B illustrates a symbolic schematic representation of co-site interference associated with prior art passive tags, wherein the same interrogation signal is received by many passive tags nearby, with each tag responding by generating its own separate return signal such that a plurality of similar return signals are simultaneously received by a reader.

FIG. 2A illustrates a symbolic schematic representation of an ideal non-interference scenario for threshold sensing using passive Ising tags as shown and described herein. Each of the passive Ising tags only produces a backscattered signal when a threshold violation of its parameter of interest (PoI) occurs. As a result, tags that do not detect any violations will not generate a return signal, even when those tags receive interrogation signals with comparable power levels.

FIG. 2B illustrates a simplified circuit schematic of an Ising tag having two parametric oscillators (POs) coupled by a coupling element and power combined at its output. The Ising tag is terminated using an input and output antenna operating at fₚ and fₚ/2, respectively.

FIG. 2C illustrates an example of the phase synchronization dynamics of the Ising tag of FIG. 2B by which it embeds its PoI threshold sensing functionality. As shown, exposure to or detection of a threshold PoI can change the preferred coupling state between the POs, wherein the tag produces either in-phase (ferromagnetic) or out-of-phase (anti-ferromagnetic) output signals.

FIG. 2D illustrates an output waveform of the Ising tag of FIG. 2B when the POs are either in an anti-ferromagnetic (out-of-phase) or ferromagnetic (in-phase) coupling state.

FIG. 3A illustrates a circuit schematic of an Ising tag in accordance with various embodiments. The tag includes two POs coupled together using a coupling element Z. including a PoI sensitive element (e.g., a piezoelectric microacoustic resonator Zᵣₑₛ as shown) and a power combiner (e.g., a Wilkinson power combiner as shown).

FIG. 3B illustrates a Butterworth Van-Dyke (BVD) circuit model of the PoI sensitive piezoelectric resonator (Zᵣₑₛ) of the coupling element (Z_{C}) of FIG. 3A.

FIG. 3C illustrates a BVD circuit model of the power combiner of FIG. 3A. The power combiner's equivalent circuit includes two equal transmission lines with characteristic impedance equal to (Z_{TL}) connected to an isolation resistance (Rᵢₛₒ).

FIG. 3D illustrates a symbolic schematic of an Ising tag that is tailored for the application of the even and odd mode circuit technique. No input antenna is shown but the output antenna's input impedance (Z_{L}). To use the even and odd mode circuit decompositions, Z_{L} is shown as a parallel combination of two equal resistors with resistance 2Z_{L} while Zᵣₑₛ is shown as a series of two identical impedances equal to Zᵣₑₛ/2. An axis of symmetry is drawn to illustrate the basis for the even and odd mode circuit analysis.

FIG. 3E illustrates even mode decomposition of the Ising tag, wherein an equivalent impedance Z_{eq} connected to each PO is unaffected by Zᵣₑₛ, while being set strictly by Z_{W,E}.

FIG. 3F illustrates odd mode decomposition of the Ising tag, wherein the equivalent impedance Z_{eq} connected to each PO includes both Zᵣₑₛ/2 and Z_{W,O}.

FIG. 4A illustrates a numerically extracted difference between P_{th,E} and P_{th,O} wherein the coupling impedance Z_{C} includes only a LiNbO₃ piezoelectric resonator and wherein a range of fₚ values corresponding to fₚ/2 values are close to the series resonance frequency of the LiNbO₃ piezoelectric resonator.

FIG. 4B illustrates a numerically extracted difference between P_{th,E} and P_{th,O} wherein Z_{C} includes both the LiNbO₃ piezoelectric resonator and a power combiner for the same range of fₚ used for FIG. 4A.

FIG. 4C illustrates numerically extracted trends of P_{th,E} and P_{th,O} with respect to different Tₐ values and an arbitrarily selected fₚ/2 value of 432 MHz.

FIG. 4D illustrates numerically extracted trends of P_{th,E} and P_{th,O} with respect to different Tₐ values and an arbitrarily selected fₚ/2 value of 438 MHz.

FIG. 5 illustrates a schematic of an experimental setup used for a wired experiment used to extract Pₜₕ of an Ising tag, wherein a signal generator is connected directly to the input of the Ising tag and the output signal is connected to a spectrum analyzer.

FIG. 6A illustrates a schematic of an experimental setup used for a wireless experiment wherein a signal generator connected to a power amplifier and a directive antenna interrogates the Ising tag situated atop a heated chuck. The backscattered signal is captured via an antenna through a spectrum analyzer and the fₚ/2 signal power received at the spectrum analyzer (P_{R}) is measured for each value of fₚ and Tₐ.

FIG. 6B illustrates measured P_{R} of the experimental Ising tag over a range of fₚ/2 values, including fₗ and fₕ, when considering different Tₐ values.

FIG. 6C illustrates measured P_{R} for various Tₐ and fₚ values (as shown fₚ is indicated in terms of fₚ/2), demonstrating the ability to reprogram the Ising tag's temperature threshold.

FIG. 6D illustrates measured and numerically predicted trends of fₗ and fₙ with respect to Tₐ.

FIG. 6E illustrates measured Δϕ values at Tₐ=25° C. for Pin varying between −5 dBm and 5 dBm, when considering two different fₚ values (corresponding to fₚ/2 values equal to 440 MHz and 441 MHz)

FIG. 7A illustrates a schematic of an Ising tag for multidimensional threshold sensing (e.g., based on three different PoIs as shown).

FIG. 7B illustrates the connectivity and coupling scheme used by the Ising tag of FIG. 7A.

FIG. 7C illustrates a locus containing all combinations of the values of R₁₂, R₂₃, and R₃₄ for which the 4 POs in the Ising tag of FIG. 7A constructively interfere to yield a strong Pₒᵤₜ, wherein R₁₃ is assumed to be 120 Ω.

FIG. 7D illustrates a deployed system having multiple multidimensional Ising tags to aid in solving optimization problems through remote sensing data acquired by a set of multidimensional Ising tags at various locations.

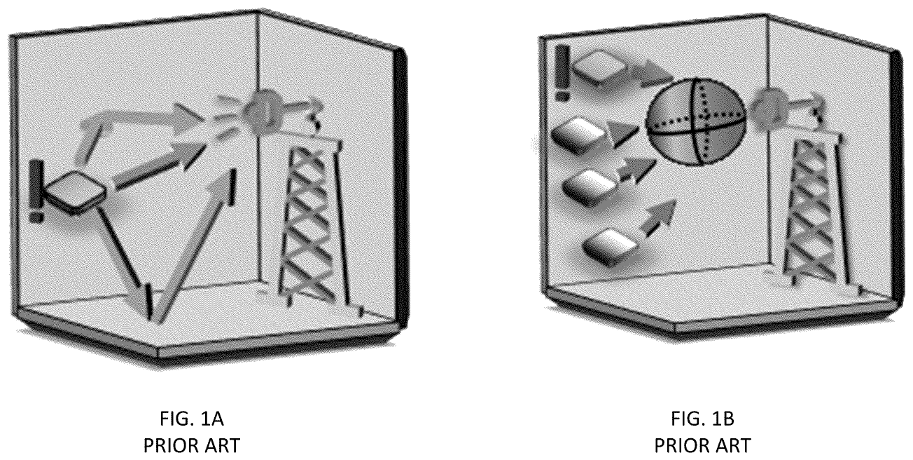

### DETAILED DESCRIPTION

The present technology provides the incorporation of Ising dynamics into radio frequency (RF) wireless technologies and offers the enhancement of modern wireless sensing capabilities. The present disclosure demonstrates a passive wireless sensor exploiting Ising dynamics, and its use to accurately implement threshold sensing. Implementations referred to herein as Sensing Parametric Ising Nodes (SPINs) or “Ising tags” correlate the occurrence of violations in a sensed parameter with transitions in the coupling state of two parametric oscillators (POs) acting as Ising spins. This feature renders the SPIN's accuracy unaffected by distortions in its input and output signals caused by multipath interference and also permits the reduction of co-site interference. An embodiment which is exemplified hereinbelow is that of temperature threshold sensing. Also demonstrated herein is that by coupling SPIN's two POs with a PoI-sensitive sensor element (e.g., a microelectromechanical resonant sensor such as a piezoelectric microacoustic LiNbO₃ resonator as shown herein), the PoI threshold of the SPIN can be wirelessly reprogrammed. As such, the present technology, advantageously and for the first time, provides wireless sensing by presenting the core unit of a novel passive computing system that can facilitate decision-making well beyond what is possible with existing passive technologies.

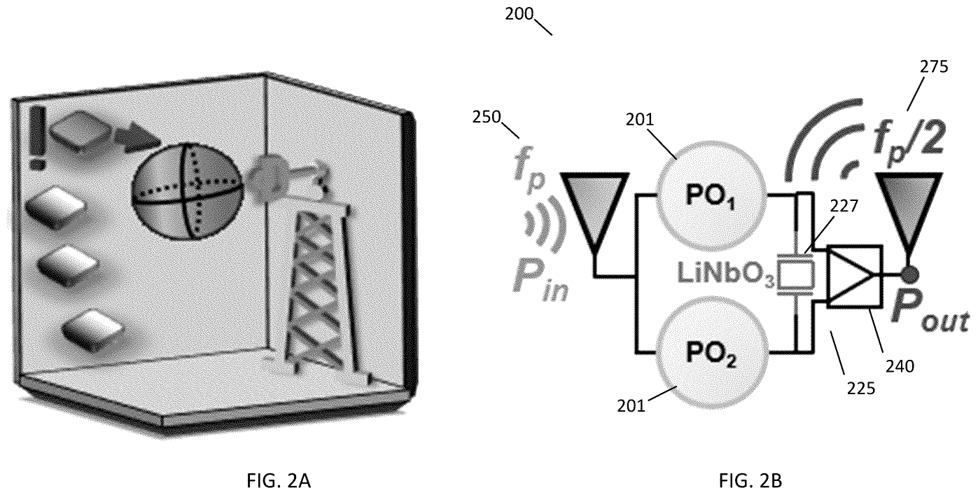

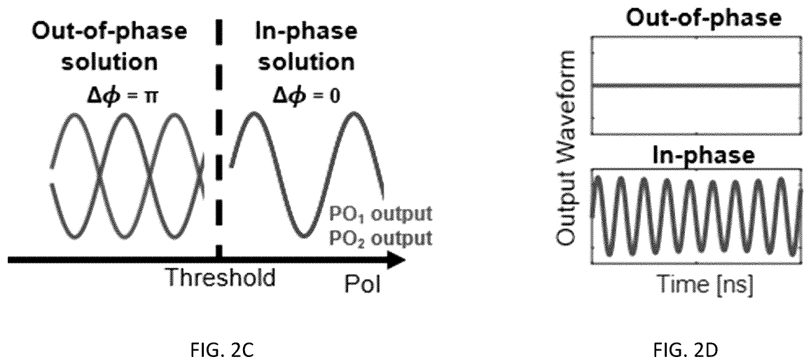

Referring now to FIG. 2B, in some embodiments, the Ising tag 200 relies on two POs 201 (PO₁ and PO₂) coupled to a dispersive impedance element 225 that, as shown, includes a resonant microelectromechanical system (MEMS) enabled sensor 227 responsive to a targeted PoI. As explained hereinbelow, such Ising tags 200 can autonomously implement threshold sensing. In particular, when driven by a continuous-wave interrogation signal, received a an input antenna 250 of the Ising tag 200 with frequency fₚ and power Pᵢₙ, the Ising tag's 200 POs 201 enter a collective oscillation state³⁵. In this state, as shown in FIGS. 2C and 2D, the POs 201 generate equal-magnitude subharmonic signals with frequency fₚ/2 and phase-difference (Δϕ) equal to 0 or π depending on the value of the sensed PoI^{31,32}. By summing the POs' 201 output signals with a power combiner 240, the output signal, whose power Pₒᵤₜ is radiated by the Ising tag's 200 output antenna 275, can either be negligible (for Δϕ=π) or strong (for Δϕ=0) due to respective destructive interference or constructive interference between the POs' 201 output signals.

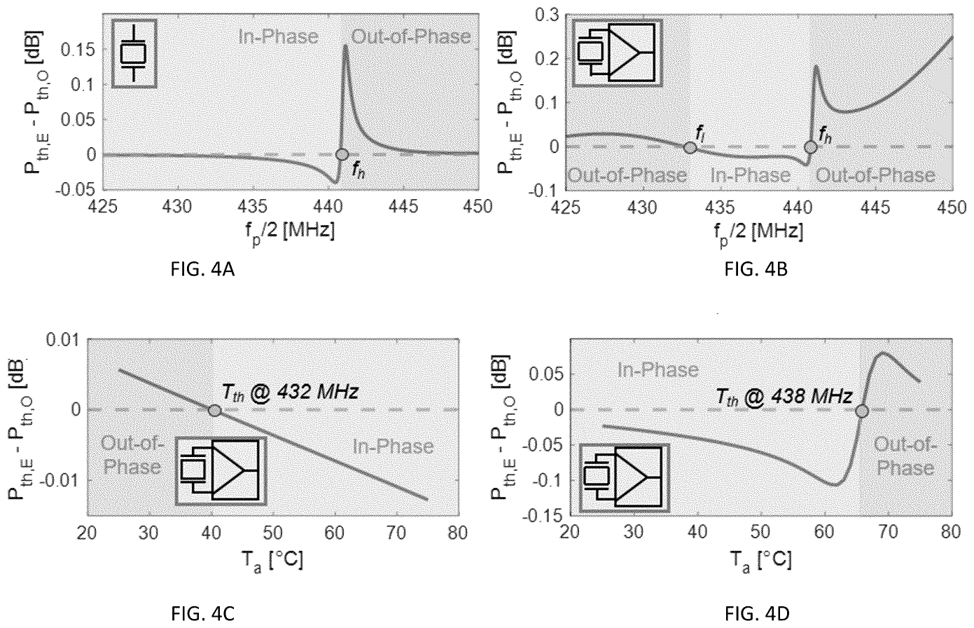

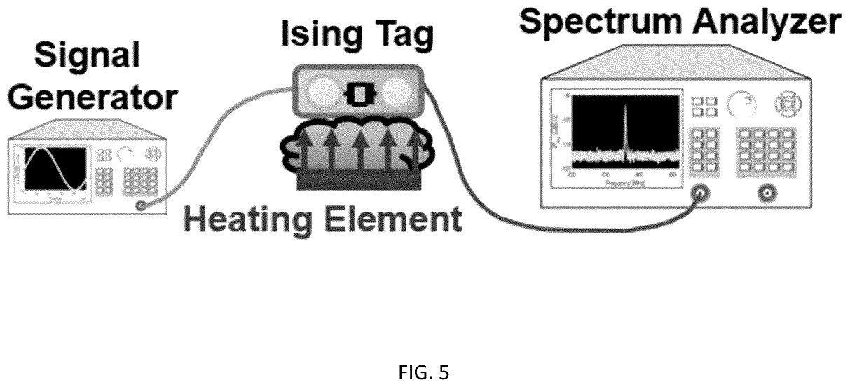

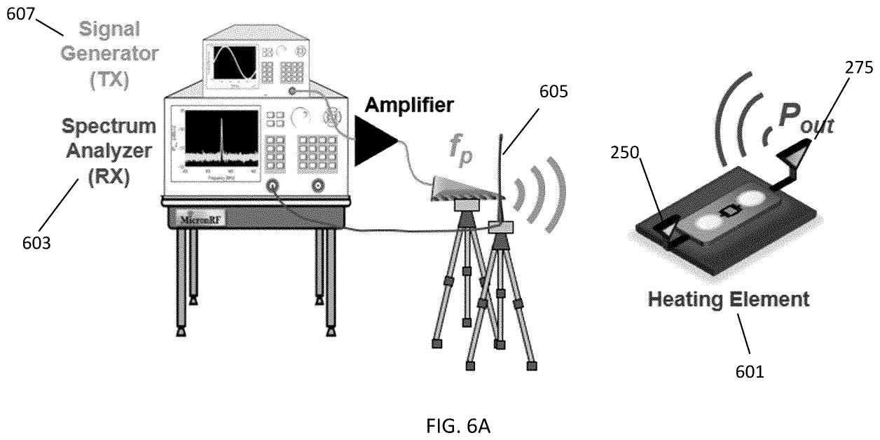

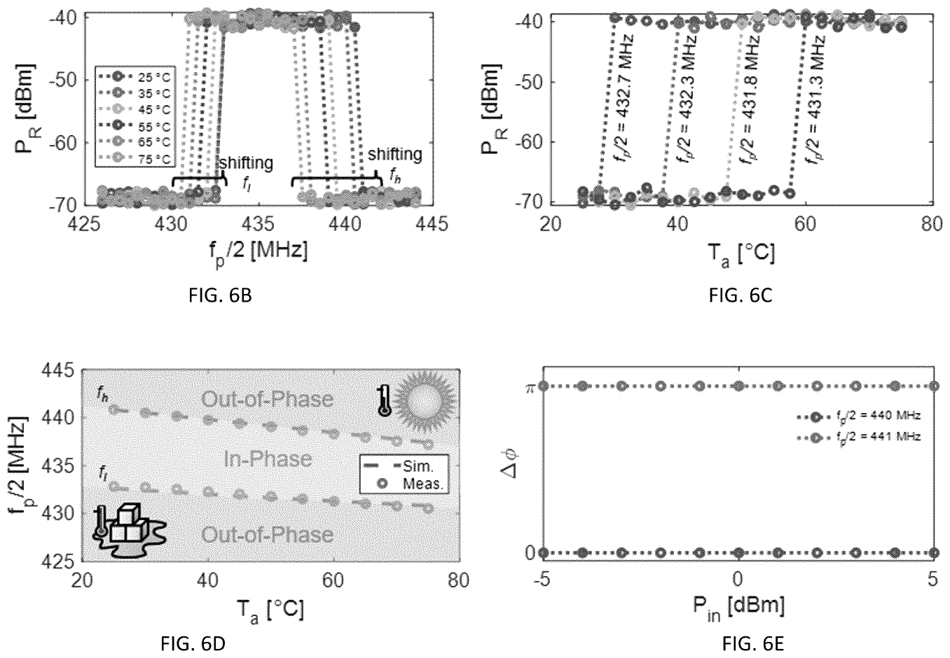

Changes in Δϕ from π to 0 or vice versa occur when the targeted PoI surpasses or becomes lower than a certain threshold value. This provides the means to generate a trigger signal when a threshold violation in the PoI occurs. Because the occurrence of a PoI violation is encoded into the generation and radiation of a strong subharmonic signal and not into specific amplitude or phase values of the Ising tag's output signal, the reader accuracy is not affected by multipath interference distorting the Ising tag's output signal. In addition, as shown, for example, in FIG. 2A, the Ising tag's readers also experience minimal impact from co-site interference generated by other Ising tags placed nearby because the output signal of any Ising tag remains negligible when no violation is detected. Another advantage of the present technology, as described in further detail below with reference, for example, to FIGS. 4B-4D and 6C, is that the Ising tags can be wirelessly programmed to exhibit different sensing thresholds by varying the input (pump) frequency fₚ.

Yet another advantage is that the generation of the Ising tag's strong output signal stems from the synchronization of its two POs and not from the triggering of a bifurcation, thus making Δϕ independent of Pᵢₙ^{32,36}. This represents a significant advancement compared to previous nonlinear passive tags, as it makes the detection of PoI violations immune to fluctuations in Pᵢₙ, despite the Ising tag's inherent nonlinear behavior. In turn, Pᵢₙ must remain larger than the minimum threshold power required (Pₜₕ) to start the POs' subharmonic oscillations, independent of the surrounding conditions.

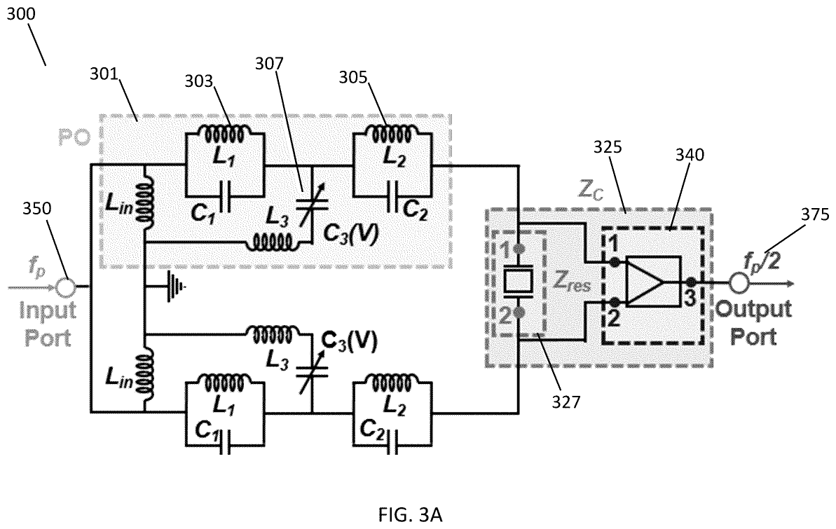

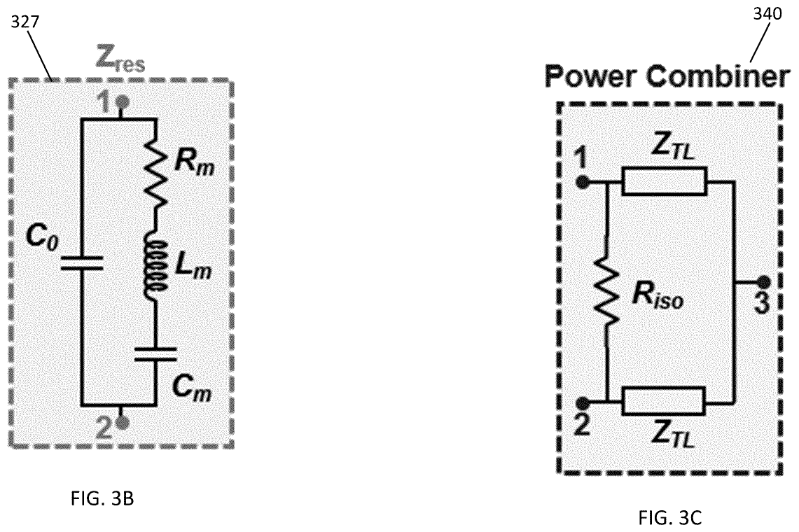

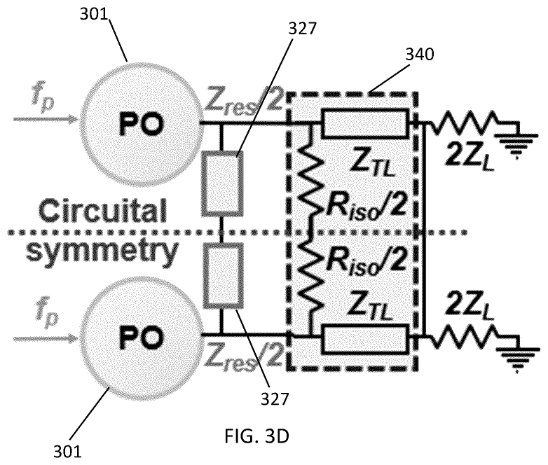

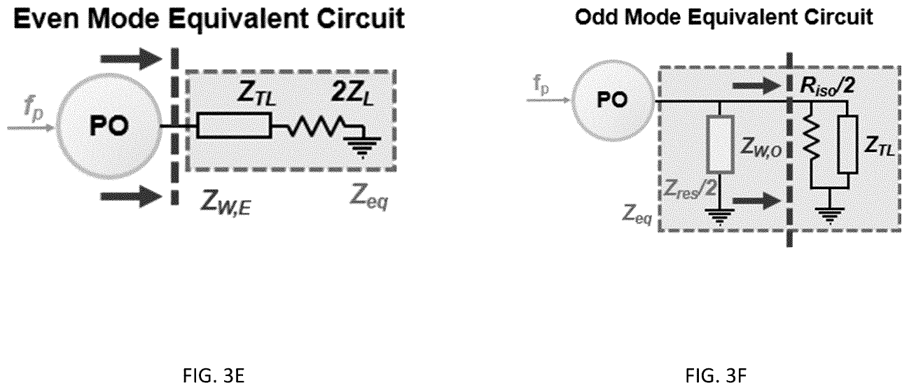

The design, principle of operation, and experimental characterization of an Ising tag prototype specifically tailored for temperature threshold sensing are described below with reference, for example, at least to FIGS. 3A-3F, 4A-4D, 5, and 6A-6E. This prototype relies on a microfabricated lithium niobate (LiNbO₃) MEMS resonant device serving as a temperature sensor, in conjunction with two POs constructed from off-the-shelf lumped components. However, it will be apparent in view of this disclosure that any number of PoI sensitive devices, resonators, off-the-shelf, and/or custom components can be used in various combinations to provide threshold sensing and/or multidimensional threshold sensing Ising tags having desired characteristics and/or their constituent components such as POs, sensor elements, resonators, antennas, transceivers, ports, etc. in accordance with various embodiments.

Referring now to FIGS. 3A-3F, an Ising tag 300 exploits the synchronization dynamics of two POs 301 coupled by a coupling element 325 providing a dispersive electrical load (e.g., the combination of a piezoelectric microacoustic resonant sensor 327 and a power combiner 340) to generate strong or weak output signals depending on the value of a sensed parameter of interest (PoI). Referring now to FIGS. 3A-3C, each PO 301 in the exemplified Ising tag 300 includes of a passive circuit formed by two resonant meshes (input mesh 303, output mesh 305) (e.g., LC tanks as shown). Each PO 301 also includes a nonlinear component 307 (e.g., a varactor a shown) responsible for parametric gain. Selection of the lumped electrical components in the POs 301 should be tailored to satisfy four resonant conditions³⁷. Specifically, the selected components forming the input mesh 303, the output mesh 305, and the nonlinear component 307 need to simultaneously series resonate (or parallel resonate) the input and output meshes 303, 305 of each PO 301 at fₚ (or fₚ/2) and fₚ/2 (or fₚ), respectively. This allows maximization of both the voltage at fₚ produced by the interrogation signal across each PO's 301 varactor 307 and the parametric gain, which is important to minimize Pₜₕ.

The POs 301 exhibit inherent bistability when operating in their period-doubling regime^{30,31,36}. As a result, they express two possible solutions for input power levels higher than Pₜₕ: one stable and one unstable. These solutions are phase-shifted by π with respect to each other and, in the absence of noise, can be reached equiprobably³². When two POs are coupled by an impedance Z_{C} as shown in FIG. 3A, they converge to a state where their output signals are either in-phase (the “ferromagnetic coupling state”) or out-of-phase (the “anti-ferromagnetic coupling state”) depending on Z_{C}, emulating two spins of an Ising system with different coupling weights^{28,33}. For the experimental Ising tag 300, Z_{C} 325 is a combination of the dispersive impedances of the resonant sensor 327 and the power combiner 340, as also shown in FIG. 3A. A Wilkinson power combiner 340 terminated to a load impedance (Z_{L}) of 50 Ω is considered here, as in the experiments³⁸ described herein.

To understand what drives the convergence of the POs 301 toward a ferromagnetic or anti-ferromagnetic coupling state, it is useful to employ an “even and odd mode” circuit analysis³⁹ to analyze the stability of the non-dividing solution (the “trivial” solution) for two POs 301 coupled by Z_{C} 325. This technique, as shown in FIGS. 3D-3F, allows decomposition of the Ising tag's 300 circuit into two separate circuits, namely the “even” FIG. 3E and “odd” FIG. 3F equivalent circuits, by leveraging circuit symmetry. Both the even and the odd circuits are effectively formed by only one PO 301 loaded with a generally complex equivalent impedance Ze_{q}. In FIGS. 3E and 3F, Z_{eq} is different for the two circuit modes. In the even mode of FIG. 3E, Z_{eq} does not depend on the resonant sensor but only on the input impedance (Z_{W,E}) of the even mode decomposition of the power combiner 340³⁸. In the odd mode of FIG. 3F, the value of Z_{eq} for the odd mode depends on both the resonant sensor's 327 impedance (Zᵣₑₛ) and the input impedance (Z_{W,O}) of the odd mode decomposition of the power combiner 340³⁸. It is important to note a fundamental distinction in the interpretation of even and odd mode equivalent circuits of a network of two POs 301 compared to their typical interpretation in linear circuits. While in linear and symmetric circuits any voltage, current, or power can be determined by superimposing the voltages, currents, and powers obtained from the even and odd mode equivalent circuits individually, this is not true for a network of two coupled POs 301^{38.39}. In such a nonlinear network, only one equivalent circuit accurately depicts the network's behavior when the input power received at input port 350 exceeds the threshold (i.e., when Pᵢₙ≥Pₜₕ) because the POs' output signals, transmitted from output port 375, are constrained to be either in-phase or out-of-phase. Specifically, the even circuit captures the network's behavior when the two POs are in a ferromagnetic coupling state (when the two POs' output signals are in-phase) whereas the odd circuit captures the network's behavior when the two POs are in an anti-ferromagnetic coupling state (when the two POs' output signals are out-of-phase). The even and odd modes of a network of two POs then compete against each other to determine the final state.

To understand which PO's coupling state wins this competition, it is necessary to identify which coupling state is activated first when the POs' driving power is increased from zero to any value above Pₜₕ^{29,33}. In this regard, the power threshold of any varactor-based electrical PO is directly related to the impedance seen by its varactor³⁷ at both fₚ and fₚ/2. Consequently, the even and odd circuits shown in FIGS. 3E and 3F exhibit different Pₜₕ values, “P_{th,E}” and “P_{th,O}”, respectively. Hence, the preferred coupling state for Pᵢₙ≥Pₜₕ can be determined by identifying which equivalent circuit between the even and odd mode circuits exhibits the lowest Pₜₕ, which depends on Z_{eq} (see FIGS. 3E-3F)^{29,33}.

Referring now to FIGS. 4A-4D, the trends of P_{th,E} and P_{th,O} with respect to fₚ were modeled. In FIG. 4A, the POs were coupled with a piezoelectric resonator matching the one used in the Ising tag prototype 300 described herein but, as an initial baseline, no power combiner was used, and SPIN's POs were assumed to be terminated on separate 50 Ω resistors. Additionally, it was assumed that the entire system is operating at room temperature (i.e., 25° C.). The piezoelectric resonator, a LiNbO₃ device like the one used in this work, was modelled through its equivalent temperature-dependent Butterworth Van-Dyke (BVD) model⁴⁰, which makes it possible to capture the resonator's mechanical behavior in the electrical domain. When Z_{C} is just comprised of the resonant sensor, the dispersion of Zᵣₑₛ makes SPIN's preferred coupling state dependent on fₚ. In this scenario, there exists one fₚ value, corresponding to a fₚ/2 value labeled as fₕ in FIG. 4A, marking the transition between ranges of fₚ favoring either ferromagnetic or anti-ferromagnetic coupling states. Specifically, P_{th,O} is lower than P_{th,E} when fₚ/2 is higher than fₕ, (so the system prefers an anti-ferromagnetic coupling state), while the opposite is true when fₚ/2 is lower than fₕ. Further, fₕ matches closely the resonance frequency (fᵣₑₛ) of the LiNbO₃ device.

Next, as shown in FIG. 4B, P_{th,E} and P_{th,O} were extracted while considering the POs coupled by both the piezoelectric resonant sensor and the power combiner used for the Ising tag prototype 300. As shown in FIG. 4B, it was found that the dispersive impedance of the power combiner creates a second transition point in the preferred coupling state. This transition occurs at a fₚ value corresponding to a fₚ/2 value labeled as fₗ in FIG. 4B. Specifically, when fₚ/2 is lower than fₗ, P_{th,O} is lower than P_{th,E} (i.e., the anti-ferromagnetic coupling state is preferred). In contrast, when fₚ/2 lies between fₗ and fₕ, the system exhibits a P_{th,O} value higher than P_{th,E}, and a ferromagnetic coupling configuration is favored. Piezoelectric resonators, like the resonant sensors described herein, inherently exhibit sensitivity to ambient temperature (Tₐ) owing to the temperature coefficient of the Young's modulus of their constituent layers⁴⁰. As a result, their resonance frequencies are detuned by any change (ΔTₐ) in Tₐ. Thus, when a piezoelectric resonator is used to couple two POs driven at fₚ, together with a power combiner, the POs' preferred coupling state becomes dependent on the ambient temperature following the resonator's Temperature Coefficient of Frequency (TCF, equal to −165 ppm/° C.)^{40,41}. As a result, while the POs may prefer a particular coupling state at a certain Tₐ, there exists a temperature threshold value (Tₜₕ) for any possible fₚ value at which the preferred coupling state changes. As shown in FIGS. 4C and 4D, this behavior was numerically confirmed by extracting P_{th,E} and P_{th,O} when considering the same piezoelectric resonant temperature sensor and power combiner considered in FIG. 4B while assuming a Tₐ value varying between room temperature and 75° C. During this numerical investigation, SPIN's behavior was studied vs. Tₐ for two distinct fₚ values, corresponding to fₚ/2 values of 438 MHz (near fₕ, see FIG. 4C) and 432 MHz (near fₗ, see FIG. 4D). In FIG. 4D it is shown that P_{th,E} was found to be lower than P_{th,O} for Tₐ<66° C., indicating that the system prefers a ferromagnetic coupling state. Once Tₐ exceeds 66° C., P_{th,E} becomes higher than P_{th,O} and the system starts favoring an anti-ferromagnetic coupling state. Thus, in this scenario, Tₜₕ is equal to 66° C. The opposite behavior was observed, as shown in FIG. 4D, for fₚ/2=432 MHz because the system reacts to a Tₐ value exceeding 40° C. by making P_{th,E} lower than P_{th,O}. This rich behavioral profile was corroborated by Harmonic Balance simulations^{42,43}, which indicates that SPIN can be used to implement the detection of violations in both directions of a set threshold through the proper selection of fₚ.

### Experimental Design and Results

To experimentally demonstrate the operational principle of SPIN, a prototype Ising tag 300 as described above with reference to FIGS. 3A-3F was designed, built, and tested on a printed circuit board (PCB) using off-the-shelf components and the same LiNbO₃ piezoelectric resonator 327 described above. The resonator was connected to the PCB using wirebonding. The assembled Ising tag comprises two identical POs 301 coupled by the LiNbO₃ device 327 and a Wilkinson power combiner 340 as shown in FIG. 3A. As shown in FIG. 6A, two off-the-shelf antennas (input antenna 250 and output antenna 275) operating around the targeted fₚ value (876 MHz, corresponding to fₚ/2=438 MHz) were connected at the POs' 301 input and output ports 350, 375 respectively, as schematically described in FIG. 2B. In the wireless experiment shown and described in connection with FIGS. 6A-6E these antennas 250, 275 were used to receive the interrogation signal and radiate the Ising tag's 300 output signal (the combined output signal resulting from the power-combined sum of the POs' 301 output signals). The LiNbO₃ piezoelectric resonator 327 was fabricated using microfabrication processes. At ambient temperature, this device had a fᵣₑₛ value (˜441 MHz) close to the targeted fₚ/2 value. Also, it showed a quality factor (Q) of 2214 and an electromechanical coupling coefficient⁴⁰ (kₜ²) of 16.9%.

Characterization of the prototype Ising tag 300 began by extracting the Pₜₕ value of its POs 301. This was done by performing a wired experiment, shown in FIG. 5, in which the input and output ports of PO₁ were connected to a signal generator and a spectrum analyzer, respectively. The signal generator was configured to produce a continuous-wave signal with frequency varying in finite steps from 428 MHz to 448 MHz. For each analyzed frequency value, the applied RF power was increased from −20 dBm until power at half of the input frequency was generated. Pₜₕ was found to vary between ˜−5 dBm and −7 dBm across the spanned frequency range. Also, PO₁ and PO₂ were found to have nearly an identical power threshold despite inherent differences between the POs' 301 components caused by process variations and components' tolerance.

Next, the prototype Ising tag's 300 temperature characterization was started via the wireless experiment illustrated in FIGS. 6A-6E. To this end, the antennas 250, 275 and power combiner were connected to the Ising tag 300 to produce a configuration as shown in FIG. 2B, and the assembled prototype Ising tag 300 was placed on top of a temperature-controlled heating chuck 601. This allowed electronic control of the Ising tag's 300 temperature and, consequently, the fᵣₑₛ value of the LiNbO₃ device 327. The prototype Ising tag 300 was wirelessly interrogated at different frequencies from a one-meter distance. A spectrum analyzer 603, connected to an off-the-shelf antenna 605, was used to emulate the operation of the receiving module of a reader. Also, the spectrum analyzer 603 was placed on top of a signal generator 607 used to generate the interrogation signal, as shown in FIG. 6A. During this test, fₚ was varied between 852 MHz and 888 MHz, with 1 MHz steps. For each frequency value, a wirelessly transmitted power of 30 dBm was considered, which is enough to ensure that the Ising tag's 300 received power is above Pₜₕ. The Ising tag's 300 output power was measured for each explored frequency value. This was done by measuring the power at fₚ/2 received by the spectrum analyzer (P_{R}).

As expected, the assembled prototype Ising tag 300 activated a ferromagnetic coupling state between its POs 301 within a limited range of fₚ/2 values, consistent with the modeling of FIG. 4B. Matching predictions, both the lowest and the highest frequencies of this frequency range (fₗ and fₕ) depend on Tₐ, as shown in FIG. 6B. When Ising tag 300 is interrogated at a frequency fₚ=fₓ lower than the room-temperature value for 2fₗ, there is a specific Tₐ value (i.e., Tₜₕ) above room temperature that renders fₗ equal to fₓ/2. As a result, for Tₐ≥Tₜₕ, the two POs 301 prefer a ferromagnetic coupling state, allowing the generation of a strong subharmonic output signal at fₓ/2. Similarly, when one interrogates the assembled SPIN prototype at a frequency fₚ=fₓ such that fₓ/2 is slightly higher than fₕ at room-temperature, there exists another Tₐ value (lower than room temperature) at which fₕ shifts up sufficiently to equate to fₓ/2. This inevitably triggers a change in the POs' preferred coupling state from anti-ferromagnetic to ferromagnetic and leads to the generation of a strong subharmonic output signal at fₓ/2. In other words, the Ising tag's Tₜₕ value is ultimately controllable by changing fₚ. When fₚ/2 is outside the range bounded by fₗ and fₕ for all considered Tₐ values, PO₁ and PO₂ always prefer an anti-ferromagnetic coupling state, which leads to a negligible output power level (ideally no power at all).

A second experiment was run, with results shown in FIG. 6C, to demonstrate the ability of Ising tags 300 to have their Tₜₕ value remotely programmed. In this experiment, four different fₚ values were selected (corresponding to fₚ/2 values of 432.7 MHz, 432.3 MHz, 431.8 MHz, and 431.3 MHz), all lower than the room-temperature value of fₗ. Then, a 30 dBm continuous wave signal was transmitted at each one of these selected frequencies while sweeping the temperature of the heating chuck from 25° C. to 75° C., as shown in FIG. 6C. Meanwhile, P_{R} was recorded as shown in FIG. 6B. As expected, P_{R} becomes significant for Tₐ values higher than a Tₜₕ value that depends on the selected fₚ value. Through the same experimental set-up, distributions of fₗ vs. Tₐ and fₕ vs. Tₐ were also extracted, as reported in FIG. 6D. These two curves effectively map the correlation between Tₜₕ and fₚ for both threshold sensing modalities that the Ising tags can exploit. Both trends in FIG. 6D closely match the simulated trends found through circuit analysis.

Finally, the resilience of the preferred coupling state to fluctuations in the input power that may occur due to multipath interference was evaluated. This experiment was critical because multipath interference is a feature that makes any prior threshold-sensing device exploiting bifurcations unusable^{18,19}. This was done through a wired experiment in which the two antennas 250, 275 were disconnected, and the Ising tag's 300 input and output ports 350, 375 were connected to a 50 Ω signal generator and to a 50 Ω oscilloscope, respectively. During this last experiment, the assembled prototype Ising tag 300 was kept at room temperature and the output port of each PO 301 was connected to different ports of an oscilloscope. Then, two fₚ/2 values (441 MHz and 440 MHz) were arbitrarily selected, resulting in different preferred coupling states (anti-ferromagnetic and ferromagnetic, respectively) at room temperature. Next, Pᵢₙ was swept from −5 dBm to 5 dBm. This 10 dB variation serves to emulate the effect of multipath perturbing the Ising tag's 300 input power when operating in uncontrolled electromagnetic environments³⁸. While sweeping Pᵢₙ, the phase difference between the POs' output signal (i.e., Δϕ) was monitored. As shown in FIG. 6E, Δϕ was found to be independent from Pᵢₙ, which is a key feature that distinguishes SPIN from any prior nonlinear passive tag and makes it accurately usable for threshold sensing even when SPIN's interrogation signal is distorted by multipath.

Thus, the present technology introduces a new class of wireless sensing devices that can leverage synchronization dynamics typical of Ising systems to passively implement threshold sensing at RF with a wirelessly programmable threshold value. SPINs allow reader devices to reliably identify violations of a targeted PoI even in multipath-intense settings and when many SPIN prototypes are deployed in close vicinity. The present technology also enables wireless reconfigurability of the temperature threshold and allows a single Ising tag to detect events where the ambient temperature rises above or drops below a certain programmable threshold.

### Multidimensional Threshold Sensing

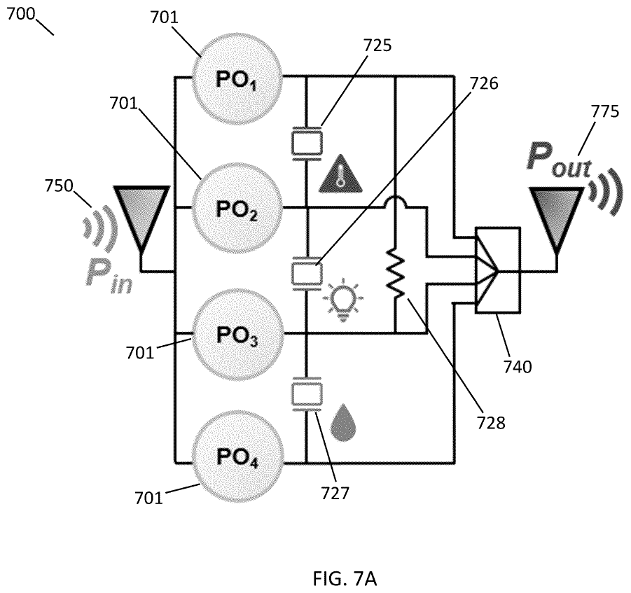

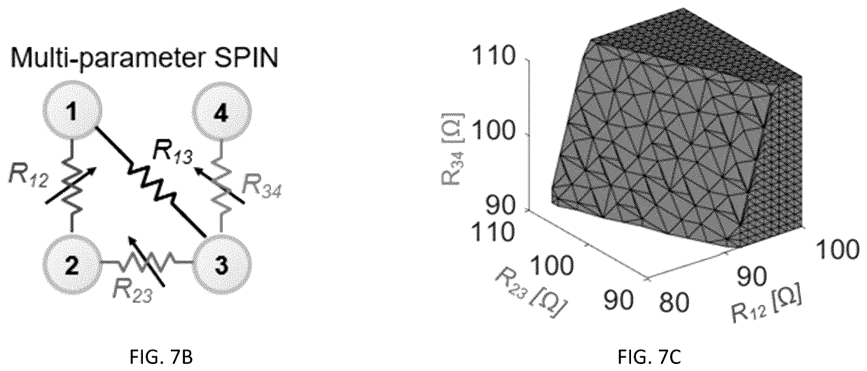

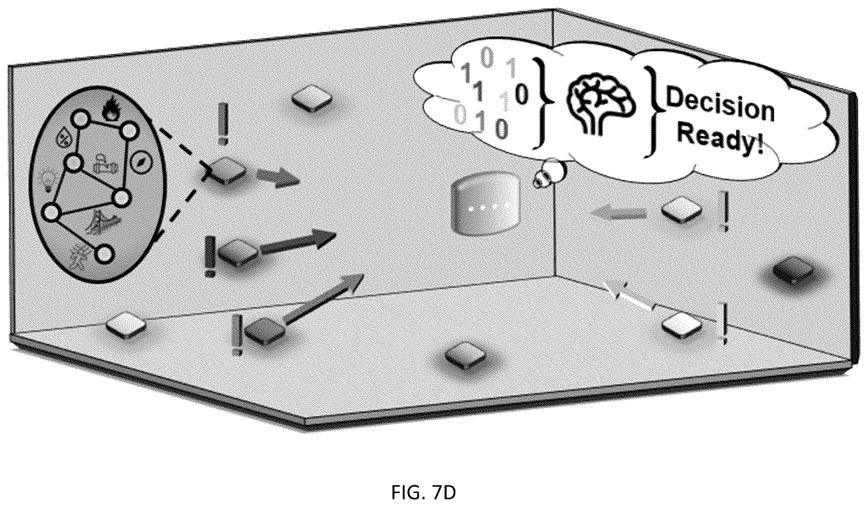

In some instances, one or more different PoIs are interrelated and, therefore, sensed values of each different PoI can affect the appropriate threshold for one or more of the other Pols and a combined multidimensional threshold is more appropriate than a linear binary threshold. For example, as shown in FIGS. 7A-7D, temperature, light, and humidity or water exposure PoIs may all be interrelated. In such applications, threshold sensors must be capable of sensing and detecting such multidimensional thresholds. As described below, it has been discovered that the principles of SPIN Ising tag technology as described above can be expanded and modified to detect such multidimensional thresholds.

FIGS. 7A-7D illustrate and describe an exemplary Ising tag 700 for multidimensional threshold sensing in accordance with various embodiments. As shown in FIG. 7A, the exemplary Ising tag 700 includes an input antenna 750, an output antenna 775, and is formed by four POs 701 (PO₁₋₄) coupled by three resonant sensors 725, 726, 727 and a fixed resistor 728, as well as a power combiner 740. The four POs 701 of the exemplary Ising tag 700 are arranged according to an arbitrarily chosen graph (see FIG. 7B). As shown in FIGS. 7A and 7B, the Ising tag 700 also includes the first resonant sensor 725 coupling PO₁ and PO₂ (R₁₂), the second resonant sensor 726 coupling PO₂ and PO₃ (R₂₃), the third resonant sensor 727 coupling PO₃ and PO₄ (R₃₄), and the fixed resistor 728 coupling PO₁ and PO₃ (R₁₃). As shown in FIG. 7A, each of the three resonant sensors 725, 726, 727 can be designed to sense a distinct PoI (e.g., temperature for the first resonant sensor 725, light for the second resonant sensor 726, and humidity for the third resonant sensor 727). This structure was numerically analyzed, and FIG. 7C illustrates a multidimensional sensing threshold of the Ising tag 700, defined and shown as a locus of all combinations of values of the three parameters of interest (R₁₂,R₂₃,R₃₄) for which the output signals of the four POs 701 constructively interfere to increase an output power of the combined output signal of the Ising tag 700. Because the exemplary Ising tag 700 is sensitive to three PoIs, the locus takes the form, shown in FIG. 7C, of a portion of a three dimensional space (the shaded portion of the plot) in which the multidimensional threshold would be violated.

However, although shown and described herein as having four POs, three sensor elements, a fixed resistor, and a three-dimensional threshold, such multidimensional Ising tags can, in some embodiments have any number of POs, coupled by any corresponding number of senor elements. In addition, in various embodiments all available PO connections can be coupled by a sensor element (e.g., sensors 725, 726, 727 coupling POs 1-2, 2-3, and 3-4 respectively as shown), some available PO connections can instead be coupled by other circuit elements (e.g., fixed resistor 728 connecting POs 1-3 as shown), and/or some available PO connections can be uncoupled (e.g., POs 1-4 and 2-4 as shown).

The resonant sensors have the same resonance frequency when not perturbed by the PoIs, and the detuning of their resonance frequency caused by the targeted PoIs is assumed to be small. This allows consideration of the impedance of each resonant sensor (Rᵢⱼ, where i and j refer to the indexes of the POs that each resonator couples) resistive and dependent on the corresponding targeted PoI. When summing the POs' output signals through a power combiner, the 4-PO Ising tag 700 of FIGS. 7A shows a strong output power only for certain R₁₂, R₂₃, and R₃₄ values. Thus, the Ising tag 700 meets the multidimensional threshold only for certain combinations of the three corresponding PoIs. This is illustrated, as noted above and as an example, the shaded volume of FIG. 7C, which includes all the possible values of R₁₂, R₂₃, and R₃₄ that lead to a strong output power level in the numerically analyzed 4-PO Ising tag 700 arbitrarily chosen as a case study. This 4-PO Ising tag 700 relies on the same graph reported in FIG. 7B for the coupling of its POs. For all the R₁₂, R₂₃, and R₃₄ values laying within the shaded volume in FIG. 7C, the POs 701 interfere with each other constructively, leading to the generation of a strong output power at half of their received signal's frequency. Conversely, the four POs 701 destructively interfere with each other when R₁₂, R₂₃, and R₃₄ are chosen to be out of the shaded volume, making the output power of the analyzed 4-PO Ising tag negligible. In other words, the analyzed 4-PO Ising tag implements multi-dimensional threshold sensing, activating a strong output signal only when the targeted PoIs fall within certain ranges of values that depend on the graph used to interconnect the POs.

The state of various multidimensional Ising tags 700 that are spatially distributed in a sensor network and that independently monitor the same set of PoIs can also help a centralized wired monitoring system 790 address certain optimization goals with higher accuracy as exemplified in FIG. 7D.

Thus, such multidimensional Ising tags enhance existing wireless sensing infrastructure with smarter passive components that can facilitate decision-making well beyond what is possible with prior art passive tags.

### Analog Computing Engines

The present SPIN Ising tag technology also makes possible the core unit of a new analog computing engine capable of reacting in real-time to changes in a group of parameters of interest. This reaction takes the form of a passively generated control signal. This control signal can be used by smart monitoring and automation systems to preserve optimal operating conditions under various scenarios, without running intense signal processing operations on wirelessly received sensing data. Moreover, because the envisioned SPIN-based computing engine autonomously produces the control signal based on its own sensed information, it does not need to transmit vast raw sensing data to a separate node with the requisite signal processing and computing capabilities. This reduces the congestion of the electromagnetic medium and the latency when multiple Ising tags are deployed for a finer-grained monitoring.

### Advantages and Practical Applications

Ising Tags are described herein having coupled RF POs. Such Ising tags are useful in connection with a variety of applications, including, for example, parametrically reconfigurable and passive threshold sensing. Theoretical analysis and experimental validation of such devices reveals a distinct property: the energetic competition between the even and odd modes, and, consequently, the Pₒᵤₜ of Ising tags is independent to changes in the received power above the Ising tags' threshold. This distinctive property advantageously provides passive threshold sensing with an accuracy that is not degraded by multi-path or perturbations in the electromagnetic environment. In fact, by leveraging the collective dynamics of the coupled POs to encode the sensed parameter instead of active components or irreversible changes in a PT's radiation profile, Ising tags enable parametric reconfigurability while avoiding using batteries or energy harvesting circuits. In this regard, these experiments indicate that it is possible to measure violations of various temperature thresholds (or other PoI thresholds) using a singular Ising tag in an uncontrolled electromagnetic environment. The collective dynamics of the coupled POs in Ising tags also permits real-time simultaneous sensing of multiple and/or multi-dimensional PoIs and sensing-based passive computation for applications demanding sensitive reconfigurable threshold monitoring and accurate read-out capabilities without using battery-powered devices.

Uses of the present technology include wireless sensing, edge sensing, identification, RFIDs, analog computing, and neural networks.

PCT/US2024/019458 is hereby incorporated by reference in its entirety.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

### REFERENCES

2. Madhvapathy, S. R. et al. Miniaturized implantable temperature sensors for the long-term monitoring of chronic intestinal inflammation. Nat. Biomed. Eng. (2024) doi:10.1038/s41551-024-01183-w.
3. Zhou, F. & Chai, Y. Near-sensor and in-sensor computing. Nat. Electron. 3, 664-671 (2020).
4. Chiu, Y.-C. et al. A CMOS-integrated spintronic compute-in-memory macro for secure AI edge devices. Nat. Electron. 6, 534-543 (2023).
5. Lenk, C. et al. Neuromorphic acoustic sensing using an adaptive microelectromechanical cochlea with integrated feedback. Nat. Electron. 6, 370-380 (2023).
6. Paesani, S. & Brown, B. J. High-Threshold Quantum Computing by Fusing One-Dimensional Cluster States. Phys. Rev. Lett. 131, 120603 (2023).
7. Landry, B. P., Palanki, R., Dyulgyarov, N., Hartsough, L. A. & Tabor, J. J. Phosphatase activity tunes two-component system sensor detection threshold. Nat. Commun. 9, 1433 (2018).
8. Okawara, H. et al. Anaerobic threshold using sweat lactate sensor under hypoxia. Sci. Rep. 13, 22865 (2023).
9. Xu, Z. et al. Reconfigurable nonlinear photonic activation function for photonic neural network based on non-volatile opto-resistive RAM switch. Light Sci. Appl. 11, 288 (2022).
10. Gauthier, D. J., Bollt, E., Griffith, A. & Barbosa, W. A. S. Next generation reservoir computing. Nat. Commun. 12, 5564 (2021).
11. Kuśmierz, Ł., Ogawa, S. & Toyoizumi, T. Edge of Chaos and Avalanches in Neural Networks with Heavy-Tailed Synaptic Weight Distribution. Phys. Rev. Lett. 125, 028101 (2020).
12. Wright, L. G. et al. Deep physical neural networks trained with backpropagation. Nature 601, 549-555 (2022).
13. Lin, R. et al. Wireless battery-free body sensor networks using near-field-enabled clothing. Nat. Commun. 11, 444 (2020).
14. Kim, Y. et al. Remote control of muscle-driven miniature robots with battery-free wireless optoelectronics. Sci. Robot. 8, eadd1053 (2023).
15. Hui, X. & Kan, E. C. Monitoring vital signs over multiplexed radio by near-field coherent sensing. Nat. Electron. 1, 74-78 (2017).
16. Hui, X. & Kan, E. C. Radio ranging with ultrahigh resolution using a harmonic radio-frequency identification system. Nat. Electron. 2, 125-131 (2019).
17. Niu, S. et al. A wireless body area sensor network based on stretchable passive tags. Nat. Electron. 2, 361-368 (2019).
18. Hussein, H. M. E., Rinaldi, M., Onabajo, M. & Cassella, C. Capturing and recording cold chain temperature violations through parametric alarm-sensor tags. Appl. Phys. Lett. 119, 014101 (2021).
19. Hussein, H. M. E., Rinaldi, M., Onabajo, M. & Cassella, C. A chip-less and battery-less subharmonic tag for wireless sensing with parametrically enhanced sensitivity and dynamic range. Sci. Rep. 11, 3782 (2021).
20. Hussein, H. M. E., Kim, S., Rinaldi, M., Alù, A. & Cassella, C. Passive frequency comb generation at radiofrequency for ranging applications. Nat. Commun. 15, 2844 (2024).
21. Biswas, K., Muthukkumarasamy, V., Bai, G. & Chowdhury, M. J. M. A reliable vaccine tracking and monitoring system for health clinics using blockchain. Sci. Rep. 13, 570 (2023).
22. Zhang, J. et al. Real-time, selective, and low-cost detection of trace level SARS-COV-2 spike-protein for cold-chain food quarantine. Npj Sci. Food 5, 12 (2021).
23. Brush, S. G. History of the Lenz-Ising Model. Rev. Mod. Phys. 39, 883-893 (1967).
24 Newell, G. F. & Montroll, E. W. On the Theory of the Ising Model of Ferromagnetism. Rev. Mod. Phys. 25, 353-389 (1953).
25. Navarro-Moratalla, E. & Jarillo-Herrero, P. The Ising on the monolayer. Nat. Phys. 12, 112-113 (2016).
26. Kalinin, K. P. & Berloff, N. G. Computational complexity continuum within Ising formulation of NP problems. Commun. Phys. 5, 20 (2022).
27. English, L. Q., Zampetaki, A. V., Kalinin, K. P., Berloff, N. G. & Kevrekidis, P. G. An Ising machine based on networks of subharmonic electrical resonators. Commun. Phys. 5, 333 (2022).
28. Heugel, T. L., Zilberberg, O., Marty, C., Chitra, R. & Eichler, A. Ising machines with strong bilinear coupling. Phys. Rev. Res. 4, 013149 (2022).
29. Xiao, P. Optoelectronics for refrigeration and analog circuits for combinatorial optimization. (University of California, Berkeley, 2019).
30. Calvanese Strinati, M., Bello, L., Pe'er, A. & Dalla Torre, E. G. Theory of coupled parametric oscillators beyond coupled Ising spins. Phys. Rev. A 100, 023835 (2019).
31. Calvanese Strinati, M. et al. Coherent dynamics in frustrated coupled parametric oscillators. New J. Phys. 22, 085005 (2020).
32. Calvanese Strinati, M. & Conti, C. Multidimensional hyperspin machine. Nat. Commun. 13, 7248 (2022).
33. Casilli, N. et al. Parametric Frequency Divider Based Ising Machines. Phys. Rev. Lett. 132, 147301 (2024).
34. Heugel, T. L. Parametrons: From Sensing to Optimization Machines. 190 p. (ETH Zurich, 2022). doi:10.3929/ETHZ-B-000543175.
35. Hong, H. & Strogatz, S. H. Conformists and contrarians in a Kuramoto model with identical natural frequencies. Phys. Rev. E 84, 046202 (2011).
36 Strogatz, S. Nonlinear Dynamics and Chaos: with Applications to Physics, Biology, Chemistry, and Engineering. (Westview Press, Cambridge, Mass, 2007).
37. Hussein, H. M. E. et al. Systematic Synthesis and Design of Ultralow Threshold 2:1 Parametric Frequency Dividers. IEEE Trans. Microw. Theory Tech. 68, 3497-3509 (2020).
38. Pozar, D. M. Microwave Engineering. (Wiley, Hoboken, NJ, 2012).
39. Roberg, M. & Campbell, C. A Novel Even & Odd-Mode Symmetric Circuit Decomposition Method. in 2013 IEEE Compound Semiconductor Integrated Circuit Symposium (CSICS) 1-4 (IEEE, Monterey, CA, USA, 2013). doi:10.1109/CSICS.2013.6659204.
40. Colombo, L., Kochhar, A., Vidal-Alvarez, G. & Piazza, G. X-Cut Lithium Niobate Laterally Vibrating MEMS Resonator With Figure of Merit of 1560. J. Microelectromechanical Syst. 27, 602-604 (2018).
41. Colombo, L., Kochhar, A., Vidal-Alvarez, G. & Piazza, G. High-Figure-of-Merit X-Cut Lithium Niobate MEMS Resonators Operating Around 50 MHz for Large Passive Voltage Amplification in Radio Frequency Applications. IEEE Trans. Ultrason. Ferroelectr. Freq. Control 67, 1392-1402 (2020).
42. Cassella, C. & Piazza, G. Low phase-noise autonomous parametric oscillator based on a 226.7 MHz AlN contour-mode resonator. IEEE Trans. Ultrason. Ferroelectr. Freq. Control 62, 617-624 (2015).
43. Suárez, A. Analysis and Design of Autonomous Microwave Circuits. (Wiley, IEEE Xplore, Hoboken, New Jersey, [Piscataway, New Jersey], 2015).

What is claimed is:

1. An Ising tag for multidimensional threshold sensing comprising:
at least three parametric oscillators (POs), each coupled to and power-combined with at least one other of the at least three POs, each of the at least three POs configured to passively activate, responsive to a pump signal exceeding a threshold power of the PO, a parametric oscillation having an oscillation frequency equal to half an angular input frequency of the pump signal, wherein an output signal of the PO can be switched between an in-phase state and an out-of-phase state;
a first sensor element for sensing a first parameter of interest, the first sensor element coupling first and second POs of the at least three POs, wherein the first sensor element is configured to set the threshold power of the first and second POs to be exceeded by a power of the pump signal responsive to a value of the first parameter of interest exceeding a first parameter of interest threshold; and
at least one additional sensor element for sensing at least one additional parameter of interest, the at least one additional sensor element coupling an additional PO of the at least three POs to one of the first PO, the second PO, or a different PO of the at least three POs, wherein the at least one additional sensor element is configured to set the threshold power of the additional PO and the one of the first PO, the second PO, or the different PO to be exceeded by a power of the pump signal responsive to a value of the at least one additional parameter of interest exceeding at least one additional parameter of interest threshold; and
a power combiner for power-combining output signals produced by the at least three POs to produce a combined output signal,
wherein a multidimensional sensing threshold of the Ising tag is defined as a locus of all combinations of values of the first and additional parameters of interest for which the output signals of the at least three POs constructively interfere to increase an output power of the combined output signal.

2. The Ising tag of claim 1, further comprising at least one resistive element coupling two otherwise uncoupled POs of the at least three POs.

3. The Ising tag of claim 1, wherein the power combiner is a Wilkinson power combiner.

4. The Ising tag of claim 1, wherein each PO further comprises:
a resonant input mesh driven by the pump signal;
a resonant output mesh coupled to the input mesh through a nonlinear component to form a parametric frequency divider; and
the nonlinear component configured to passively activate, responsive to the pump signal exceeding the threshold power of the PO, the parametric oscillation between the input and output meshes, the parametric oscillation having the oscillation frequency equal to half the angular input frequency of the pump signal,
wherein the output signal of the PO can be switched between the in-phase state and the out-of-phase state.

5. The Ising tag of claim 4, wherein the first and at least one additional sensor elements have a same resonance frequency when the values of the respective first and at least one additional parameters of interest do not exceed the respective first and at least one additional parameter of interest thresholds.

6. The Ising tag of claim 1, wherein each of the first and at least one additional sensor elements includes one or more resistive elements, inductive elements, capacitive elements, resonant elements, or combinations thereof.

7. The Ising tag of claim 6, wherein each of the first and at least one additional sensor elements produces a capacitive readout.

8. The Ising tag of claim 6, wherein each of the first and at least one additional sensor elements includes a combination of resistive elements, capacitive elements, and resonant elements.

9. The Ising tag of claim 6, wherein each of the first and at least one additional sensor elements includes one or more of a piezoelectric resonator, a MEMS resonator, a NEMS resonator, or a combination thereof.

10. The Ising tag of claim 1, wherein each of the first and at least one additional parameters of interest includes one or more of a physical parameter, an electrical parameter, a chemical agent, a biological agent, or combinations thereof.

11. The Ising tag of claim 10, wherein each of the first and at least one additional parameters of interest includes one or more of mass, acceleration, pressure, transduced spin waves, vibration frequency, vibration intensity, temperature, humidity, radiation concentration, radiation energy, radiation intensity, radiation type, acoustic frequency, acoustic intensity, acoustic power, acoustic phase, photonic intensity, photonic frequency, photonic phase, photonic polarization, voltage of an electrical signal, current of an electrical signal, power of an electrical signal, frequency of an electrical signal, magnetic field, concentration of a chemical agent, presence or absence of a chemical agent, concentration of a biological agent, presence or absence of a biological agent, or combinations thereof.

12. The Ising tag of claim 10, wherein at least one of the first and at least one additional parameters of interest includes a chemical agent selected from a gas, a toxin, a volatile organic compound, an atmospheric or water-born pollutant, a vehicle emission, an emission of an animal or human, soil moisture, a pharmaceutical agent or formulation ingredient, a polymer, and combinations thereof.

13. The Ising tag of claim 10, wherein at least one of the first and at least one additional parameters of interest includes a biological agent selected from a bacterium, a virus, a viral vector, a cell, an exosome, an extracellular vesicle, a cellular organelle or cell fragment, an antibody, a protein, a glycoprotein, a nucleic acid, an antigen, a tumor antigen, a sugar, an oligosaccharide, a polysaccharide, a lipid, a glycolipid, a sphingolipid, a vaccine, and combinations thereof.

14. The Ising tag of claim 4, wherein a characteristic of the nonlinear component is modulated at the angular input frequency of the pump signal.

15. The Ising tag of claim 4, wherein the nonlinear component has a nonlinear reactance.

16. The Ising tag of claim 15, wherein the nonlinear component includes one or more of a diode, a varactor, or a combination thereof.

17. The Ising tag of claim 16, wherein the nonlinear component includes a varactor and an inductor, wherein the input mesh and the output mesh are coupled through the varactor and the inductor.

18. The Ising tag of claim 4, wherein:
the input mesh includes an input filter to constrain the pump signal within the input mesh to the angular input frequency of the pump signal; and
the output mesh includes an output filter to constrain the output signal within the output mesh to half of the angular input frequency of the pump signal.

19. The Ising tag of claim 4, wherein the output mesh is configured to series-resonate at half the angular input frequency of the pump signal.

20. The Ising tag of claim 4, wherein each of the input mesh and the output mesh includes a resonator.

21. The Ising tag of claim 20, wherein each resonator includes one or more of an electrical resonator, a piezoelectric resonator, a MEMS resonator, a NEMS resonator, an optical resonator, a non-Hermitian resonator, an electromagnetic resonator, or a combination thereof.

22. A system for threshold sensing of multiple parameters of interest comprising:
an Ising tag including:
an input antenna;
an output antenna;
at least three parametric oscillators (POs), each coupled to and power-combined with at least one other of the at least three POs, each of the at least three POs configured to passively activate, responsive to a pump signal exceeding a threshold power of the PO, a parametric oscillation having an oscillation frequency equal to half an angular input frequency of the pump signal, wherein an output signal of the PO can be switched between an in-phase state and an out-of-phase state;
a first sensor element for sensing a first parameter of interest, the first sensor element coupling first and second POs of the at least three POs, wherein the first sensor element is configured to set the threshold power of the first and second POs to be exceeded by a power of the pump signal responsive to a value of the first parameter of interest exceeding a first parameter of interest threshold;
at least one additional sensor element for sensing at least one additional parameter of interest, the at least one additional sensor element coupling an additional PO of the at least three POs to one of the first PO, the second PO, or a different PO of the at least three POs, wherein the at least one additional sensor element is configured to set the threshold power of the additional PO and the one of the first PO, the second PO, or the different PO to be exceeded by a power of the pump signal responsive to a value of the at least one additional parameter of interest exceeding at least one additional parameter of interest threshold; and
a power combiner for power-combining output signals produced by the at least three POs to produce a combined output signal,
wherein a multidimensional sensing threshold of the Ising tag is defined as a locus of all combinations of values of the first and additional parameters of interest for which the output signals of the at least three POs constructively interfere to increase an output power of the combined output signal; and
a reader configured to produce the pump signal and to read the output signal, wherein the reader is configured to detect the in-phase or out-of-phase state of the Ising tag.

23. The system for threshold sensing of multiple parameters of interest of claim 22, wherein the first and at least one additional parameters of interest each include one or more of a physical parameter, an electrical parameter, a chemical agent, a biological agent, or combinations thereof.
